(19) United States
(12) Patent Application Publication
(10) Pub. No.: US 2023/0324066 A1
(43) Pub. Date: Oct. 12, 2023

(54) DYNAMIC ENVIRONMENTAL SYSTEMS AND METHODS FOR CONTROLLING ENVIRONMENTAL CONDITIONS IN A STRUCTURE BASED ON MACHINE LEARNING TECHNIQUES

(71) Applicant: Solvable Labs Inc., Austin, TX (US)

(72) Inventor: Arjun Gupta, Austin, TX (US)

(21) Appl. No.: 18/132,343

(22) Filed: Apr. 7, 2023

Related U.S. Application Data
(60) Provisional application No. 63/362,700, filed on Apr. 8, 2022.

(51) Int. Cl. F24F 11/63; G05B 19/042

(52) U.S. Cl. CPC F24F 11/63; G05B 19/042; G05B 2219/2614

(57) ABSTRACT

A method of operating a heating, air conditioning, and ventilation (HVAC) system includes determining one or more user preferences for environmental conditions in a structure. The method also includes determining one or more interior environmental parameters measured for the interior space, the one or more environmental parameters including at least one of interior temperature, interior humidity, or interior air quality. The method also includes determining one or more exterior environmental parameters measured for an exterior space outside the structure, the one or more exterior environmental parameters including at least one of exterior temperature, exterior humidity, and exterior air quality. Further, the method includes determining a ventilation decision.

### CROSS-REFERENCE TO RELATED APPLICATIONS

The present application claims the benefit of U.S. Provisional Patent Application No. 63/362,700 filed Apr. 8, 2022, entitled “FIELD-CONFIGURABLE DYNAMIC INTER-ENVIRONMENTAL FLUID COMMUNICATION”, which is hereby incorporated herein by reference in its entirety herein.

### BACKGROUND

Heating, ventilation, and air condition systems are standard features in most homes and buildings. These systems typically consist of a conditioning unit, e.g., an air conditioner and/or heater, that alters the temperature in a building based on a user-selected temperature. These systems typically include a thermostat that measures the indoor temperature of the building and activates the conditioning unit when the indoor temperature deviates from the user-selected temperature. These systems, however, do not consider other environmental factors, e.g., exterior humidity, and exterior air quality, when making a determination to activate. Further, these systems do not offer multiple options for conditioning the air within the building.

### SUMMARY

The present invention addresses the above problems by providing an active air control system having a ventilation system, a controller, and a plurality of sensors including temperature sensors. In an illustrative example, the active air control system can actively control air flow in an enclosed space based on detected indoor and outdoor environmental conditions. The detected indoor and outdoor environmental conditions, for example, can be compared to user-selected preferences. Various embodiments can advantageously determine an optimal indoor temperature adjustment strategy that selects a ventilation system or a conditioning system to achieve user-selected preferences.

For example, in some embodiments, the active air control system can reduce or prevent unnecessary operation of an air conditioning (e.g., cooling/heating) system. The active air control system can, for example, advantageously reduce energy costs and/or improve energy efficiency. In some embodiments, for example, the active air control system can advantageously increase indoor air quality. In some embodiments, for example, the active air control system can advantageously proactively control air flow and/or condition based on learned user habits and/or preferences (e.g., historical user interactions). In some embodiments, for example, the active air control system can, for example, advantageously proactively control air flow and/or condition based on historical and/or predicted indoor and/or outdoor environmental conditions (e.g., weather predictions, temperature rates of change, pressure changes, air contaminant levels) using machine learning models. Other features and advantages will be apparent from the description and drawings, and from the claims.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a diagram of an exemplary environmental system for selectively using a ventilation system in accordance with an exemplary embodiment of the invention.

FIG. 2 is a block diagram of another exemplary environmental system for selectively using a ventilation system in accordance with an exemplary embodiment of the invention.

FIG. 3A is a flow diagram of an exemplary process for selectively using a ventilation system according to one embodiment of the invention.

FIG. 3B is a flow diagram of an exemplary process for determining a ventilation decision using machine learning according to one embodiment of the invention.

FIGS. 4A-4E are several views of a ventilation device according to one embodiment of the invention.

FIG. 5 is a perspective view of a window adapter for a ventilation device according to one embodiment of the invention.

FIG. 6 is a block diagram of components of a computing device that supports an embodiment of the inventive disclosure.

### DETAILED DESCRIPTION

One or more different embodiments can be described in the present application. Further, for one or more of the embodiments described herein, numerous alternative arrangements can be described; it should be appreciated that these are presented for illustrative purposes only and are not limiting of the embodiments contained herein or the claims presented herein in any way. One or more of the arrangements can be widely applicable to numerous embodiments, as can be readily apparent from the disclosure. In general, arrangements are described in sufficient detail to enable those skilled in the art to practice one or more of the embodiments, and it should be appreciated that other arrangements can be utilized and that structural, logical, software, electrical and other changes can be made without departing from the scope of the embodiments. Particular features of one or more of the embodiments described herein can be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other can communicate directly or indirectly through one or more communication means or intermediaries, logical or physical.

A description of an aspect with several components in communication with each other does not imply that all such components are required. To the contrary, a variety of optional components can be described to illustrate a wide variety of possible embodiments and in order to more fully illustrate one or more embodiments. Similarly, although process steps, method steps, algorithms or the like can be described in a sequential order, such processes, methods and algorithms can generally be configured to work in alternate orders, unless specifically stated to the contrary. In other words, any sequence or order of steps that can be described in this patent application does not, in and of itself, indicate a requirement that the steps be performed in that order. The steps of described processes can be performed in any order practical. Further, some steps can be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they can only occur once each time a process, method, or algorithm is carried out or executed. Some steps can be omitted in some embodiments or some occurrences, or some steps can be executed more than once in a given aspect or occurrence.

When a single device or article is described herein, it will be readily apparent that more than one device or article can be used in place of a single device or article. Similarly, where more than one device or article is described herein, it will be readily apparent that a single device or article can be used in place of the more than one device or article.

The functionality or the features of a device can be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments can include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions can be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

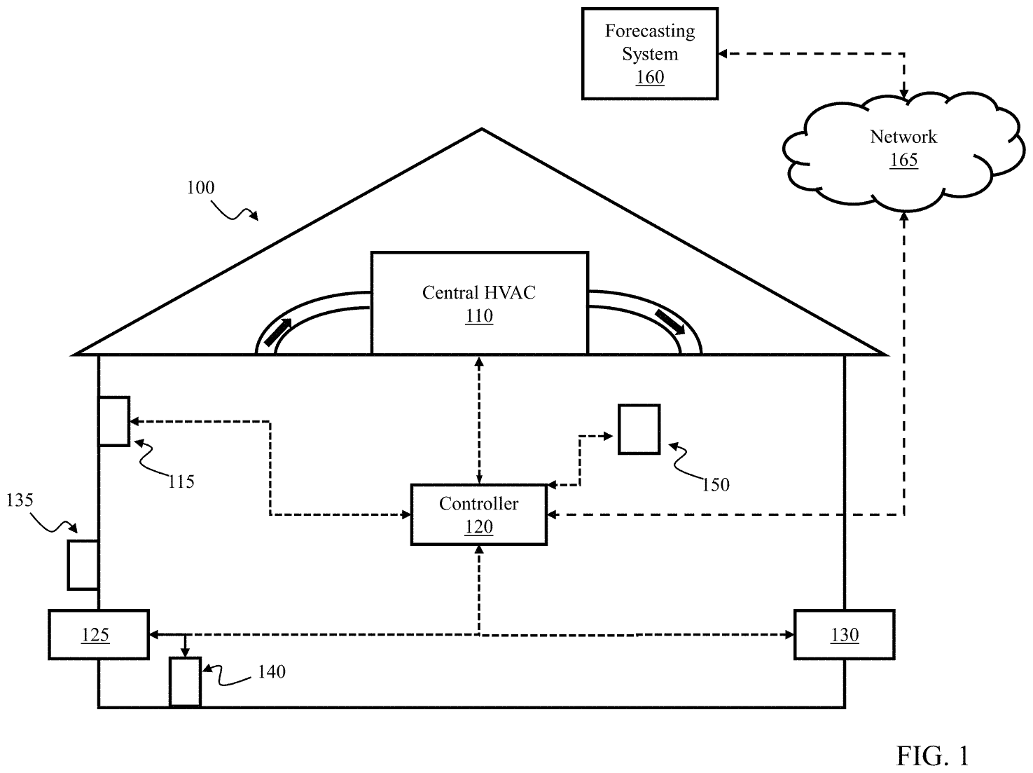

FIG. 1 illustrates an exemplary active air exchange system (AAES) according to embodiments of the present disclosure. For example, the AAES can be used to control environmental conditions in a structure 100. For example, the structure 100 can include a residential house, a commercial building, a residential apartment, commercial office space, storage unit, and the like. As described herein, the environmental conditions can include temperature, air quality, humidity, aroma, air pressure, or a combination thereof. As described herein, air quality can include factors such as levels of carbon monoxide, lead, ground-level ozone, particulate matter, nitrogen dioxide, and sulfur dioxide.

The structure 100 includes a central heating, ventilation, and air conditioning (HVAC) unit 110 connected to a control thermostat 115 in the depicted example. The HVAC unit 110 can be any type of HVAC unit that conditions the air of the structure through electrical, chemical, and/or mechanical work, for example, a heat pump, an oil furnace, an electric furnace, a refrigeration unit, a geothermal heating cell, and combinations thereof. The control thermostat 115 operates to activate the HVAC unit 110 based on user preferences. As described herein, user preferences can include a value or a range of values for one or more environmental conditions, for example, temperature, air quality, humidity, aroma, air pressure, or a combination thereof. The user preferences can also include parameters for the operation of the HVAC unit 110 and the ventilation system, described below.

For example, based on a difference between a user selected temperature, the control thermostat 115 can activate the central HVAC 110 to change one or more environmental conditions, e.g., a temperature, within the structure 100. As an illustrative example, the control thermostat 115 can include one or more environmental sensors (not shown) for detecting environmental conditions in the structure 100. For example, the control thermostat 115 can compare the user preferences with the currently measured environmental conditions in the structure 100. If, the user selected temperature is lower than the room temperature, then the control thermostat 115 can activate the central HVAC 110 to cool the structure 100, for example.

The AAES includes a controller 120 connected to the control thermostat 115. The controller 120 can be configured to send instructions to the control thermostat 115 to activate or deactivate the central HVAC 110. For example, the central HVAC 110 can be activated by the control thermostat 115 when the control thermostat 115 receives a deactivate instruction from the controller 120. Upon receiving the deactivate instruction, in some embodiments, the control thermostat 115 can deactivate the central HVAC 110. In embodiments, by way of example and not limitation, the controller 120 can be connected to the exterior environmental sensors 135. The exterior environmental sensors 135 can be configured to measure the environmental conditions that are external to the structure 100. For example, the exterior environmental sensors 135 can include temperature sensors, particular sensors, volatile organic compound sensors, humidity sensors, air pressure sensors, wind velocity sensors, location sensors, and the like. The controller 120 can be connected to interior environmental sensors 140. The interior environmental sensors 140 can be configured to measure the environmental conditions that are internal to the structure 100. For example, the interior environmental sensors 140 can include temperature sensors, particular sensors, volatile organic compound sensors, humidity sensors, air pressure sensors, wind velocity sensors, location sensors, and the like.

The AAES includes a ventilation system that selectively exchanges air from the interior of the structure 100 to the exterior of the structure 100, and vice versa, based on instructions from the controller 120. The ventilation system includes a makeup unit 125 and an exhaust unit 130. For example, the makeup unit 125 can pull air from outside into the structure 100. For example, the exhaust unit 130 can blow indoor air out of the structure 100. In this example, the makeup unit 125 and the exhaust unit 130 are connected to the controller 120. For example, the controller 120 can send instructions to independently activate the makeup unit 125 and the exhaust unit 130. In some embodiments, the controller 120 can also receive data from the makeup unit 125. For example, the makeup unit 125 can transmit environmental data, e.g., air quality information of the incoming air to the controller 120. As shown, the makeup unit 125 can be coupled to the exterior environmental sensors 135 and interior environmental sensors 140. In embodiments, the exterior environmental sensors 135 and interior environmental sensors 140 can be coupled to other components such as the controller 120 and/or the thermostat 115. By controlling the makeup unit 125 and the exhaust unit 130, under suitable circumstances, the AAES can actively control indoor environmental conditions based on measured exterior and interior environmental conditions (e.g., temperature, humidity, particulates, pollens, VOCs) and settings at the control thermostat 115, for example.

As an illustrative example shown in FIG. 1, the user selected temperature at the control thermostat 115 is set at 70° F., and the current room temperature is 71° F. In some implementations, the controller 120 can control the air quality (e.g., room temperature) in the structure 105 in two stages. In a first stage, for example, the controller 120 can compare a difference between the user selected temperature and the current room temperature. In some examples, at the first stage, the controller 120 can determine whether the structure 105 is to be cooled down or warmed up. For example, the house is to be cooled down when the user selected temperature is lower than the current room temperature.

In a second stage, for example, the controller 120 can compare a difference between the outdoor temperature and the current room temperature. If, for example, the outdoor temperature is lower than the current room temperature, and the result in the first stage is determined that the house 105 is to be cooled down, then the controller 120 can activate the makeup unit 125 to pull in cool air from outside. In some examples, to facilitate ventilation, the controller 120 can also activate the exhaust unit 130. In some embodiments, the controller 120 can prevent the control thermostat 115 to activate the central HVAC 110. Accordingly, in various implementations, the AAES can advantageously save energy used for powering the central HVAC 110. For example, 60% of time the AAES can activate the makeup unit 125 and the exhaust unit 130 to pulled in outside air between 2 AM-8 AM. In some examples, the AAES can advantageously improve indoor oxygen level and/or improve air quality by removing stale and/or pathogen-rich air from the structure 100. While the above example is described with reference to temperature, the process can operate for other environmental conditions or combinations of environmental conditions.

In embodiments, the AAES can also selectively operate the central HVAC 110 and the ventilation system using artificial intelligence and machine learning algorithms that forecast the future environmental conditions for the structure 100 and provide adaptive ventilation decisions for the structure. The AAES can implement and train one or more environmental models for the structure that outputs ventilation decisions for the AAES system. As described herein, ventilation decisions concern determining whether to selectively operate the central HVAC 110 and the ventilation system based on a combination of factors including user preferences, current interior and exterior environmental conditions, forecasted environmental conditions, historic environmental operations of the structures, historic environmental operations of the similar structures, e.g., similar in construction, HVAC system, geographic location, and climate zone, and the like. The environmental model can employ a combination of AI algorithms and methods to learn from the environmental parameters collected from indoor and outdoor sensors, weather data, and user preferences. The AAES system can utilize AI algorithms and methods to learn from the collected data and improve its forecasting and ventilation decision-making capabilities. The choice of algorithms and techniques depends on the specific requirements and constraints of the system, as well as the availability and quality of the data. The AAES can utilize a combination of these methods would be employed to achieve the best results. Examples of algorithms and techniques that can be employed by the environmental model can include but are not limited to:

Supervised learning: Supervised learning algorithms, such as linear regression or support vector machines, can be used to model the relationship between input features (e.g., air quality parameters, weather data, house parameters) and target variables (e.g., optimal ventilation settings). The model can be trained on historical data and used to make predictions for new data points.

Time series forecasting: Time series forecasting algorithms, such as ARIMA or Long Short-Term Memory (LSTM) neural networks, can be used to predict future air quality parameters based on historical data. These models can take into account temporal dependencies and trends in the data to make accurate predictions.

Clustering: Clustering algorithms, such as K-means or DB SCAN, can be used to group houses with similar characteristics or performance together. This can help identify common patterns and trends among similar houses and improve the performance of the predictive models.

Nearest neighbor search: Nearest neighbor search algorithms, such as k-Nearest Neighbors (k-NN), can be used to find houses with similar characteristics and use their historical data to make predictions for a given house. This can be particularly useful in scenarios where limited data is available for a specific house.

Collaborative filtering: Collaborative filtering techniques can be used to leverage user preferences from different houses to make personalized recommendations for optimal ventilation settings. These techniques can consider both user-based similarities and item-based similarities (in this case, house parameters and ventilation settings).

Reinforcement learning: Reinforcement learning algorithms, such as Q-learning or Deep Q-Networks (DQN), can be employed to learn the optimal ventilation strategy over time by iteratively updating the action-value function based on the observed air quality parameters, weather data, and user preferences.

The one or more environmental models can be trained using data collected from the structure 100 by the controller 120. The data can include the environmental parameters measured over time. The one or more environmental models can also be trained using data collected from other structure that exhibit similar environmental properties to the structure 100. For example, data collected from structures that are geographically near the structure 100 can be used to train the one or more environmental models. Likewise, data collected from structures with similar constructions and dimensions can be used to train the one or more environmental models.

In some embodiments, the controller 120 can be configured to implement and train the one or more environmental models. In some embodiments, the controller 120 can be coupled to a forecasting system 160 via one or more networks 165. The forecasting system 160 can be configured to operate one or more environmental models for the structure 100. In some embodiments, the forecasting system 160 can be implemented as a physical data management system. In some embodiments, the forecasting system 160 can be implemented as a cloud-based data management system. In any embodiment, the forecasting system 160 can include one or more servers such as application servers, database servers, and data servers. The various elements of the AAES and the forecasting system 160 can communicate via various communication links through the network 165.

As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

The forecasting system 160 can be web-based. In some embodiments, the controller 120 and/or the user device 150 can access the forecasting system 160 via an online portal set up and/or managed by one or more of the servers, e.g., the application server. In some embodiments, the controller 120 and/or the user device 150 can include one or more applications that access the services of the forecasting system 160 via one or more application programming interfaces (APIs) and that access the processes of providing a ventilation decision.

The AAES system can also communicate with a user device 150. The user device 150 can be any type of computerized device that can communicate with the controller 120 or the thermostat 115. A user can utilize the user device 150 to provide user preferences and control the AAES system. The user device 150 can include, generally, a computer or computing device including functionality for communicating (e.g., remotely) over a network, for example network 165. Data can be collected from the user device 150, and data requests can be initiated from each the user device 150. The user device 150 can be a server, a desktop computer, a laptop computer, personal digital assistant (PDA), an in- or out-of-car navigation system, a smart phone or other cellular or mobile phone, or mobile gaming device, among other suitable computing devices. The user device 150 can execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over the network 165. In particular embodiments, each user device 150 can be an electronic device including hardware, software, or embedded logic components or a combination of two or more such components and capable of carrying out the appropriate functions implemented or supported by the user device 150.

A user device 150 can have a web browser, such as MICROSOFT INTERNET EXPLORER, GOOGLE CHROME or MOZILLA FIREFOX, and can have one or more add-ons, plug-ins, or other extensions, such as TOOLBAR or YAHOO TOOLBAR. A user device 110 can enable a user to enter a Uniform Resource Locator (URL) or other address directing the web browser to a server, and the web browser can generate a Hyper Text Transfer Protocol (HTTP) request and communicate the HTTP request to server. The server can accept the HTTP request and communicate to the user device 150 one or more Hyper Text Markup Language (HTML) files responsive to the HTTP request. The user device 150 can render a web page based on the HTML files from server for presentation to the user. The present disclosure contemplates any suitable web page files. As an example and not by way of limitation, web pages can render from HTML files, Extensible Hyper Text Markup Language (XHTML) files, or Extensible Markup Language (XML) files, according to particular needs. Such pages can also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser can use to render the web page) and vice versa, where appropriate.

The user device 150 can also include an application that is loaded onto the user device 150. The application obtains data from AAES system and/or the forecasting system 160 and displays it to the user within the application interface. This allows the user device 150 to interact with and/or control the AAES system.

Exemplary user devices are illustrated in some of the subsequent figures provided herein. This disclosure contemplates any suitable number of user devices, including computing systems taking any suitable physical form. As example and not by way of limitation, computing systems can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system can include one or more computer systems; be unitary or distributed; span multiple locations; span multiple machines; or reside in a cloud, which can include one or more cloud components in one or more networks. Where appropriate, one or more computing systems can perform without substantial spatial or temporal limitation one or more steps of one or more methods described or illustrated herein. As an example, and not by way of limitation, one or more computing systems can perform in real time or in batch mode one or more steps of one or more methods described or illustrated herein. One or more computing system can perform at different times or at different locations one or more steps of one or more methods described or illustrated herein, where appropriate.

The network 165 generally represents a network or collection of networks (such as the Internet or a corporate intranet, or a combination of both) over which the various components illustrated in FIG. 1 (including other components that can be necessary to execute the system described herein, as would be readily understood to a person of ordinary skill in the art). In particular embodiments, the network 165 is an intranet, an extranet, a virtual private network (VPN), a local area network (LAN), a wireless LAN (WLAN), a wide area network (WAN), a metropolitan area network (MAN), a portion of the Internet, or another the network 165 or a combination of two or more such networks 165. One or more links connect the systems and databases described herein to the network 165. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 165, and any suitable link for connecting the various systems and databases described herein. The network 165 connects the various systems and computing devices described or referenced herein.

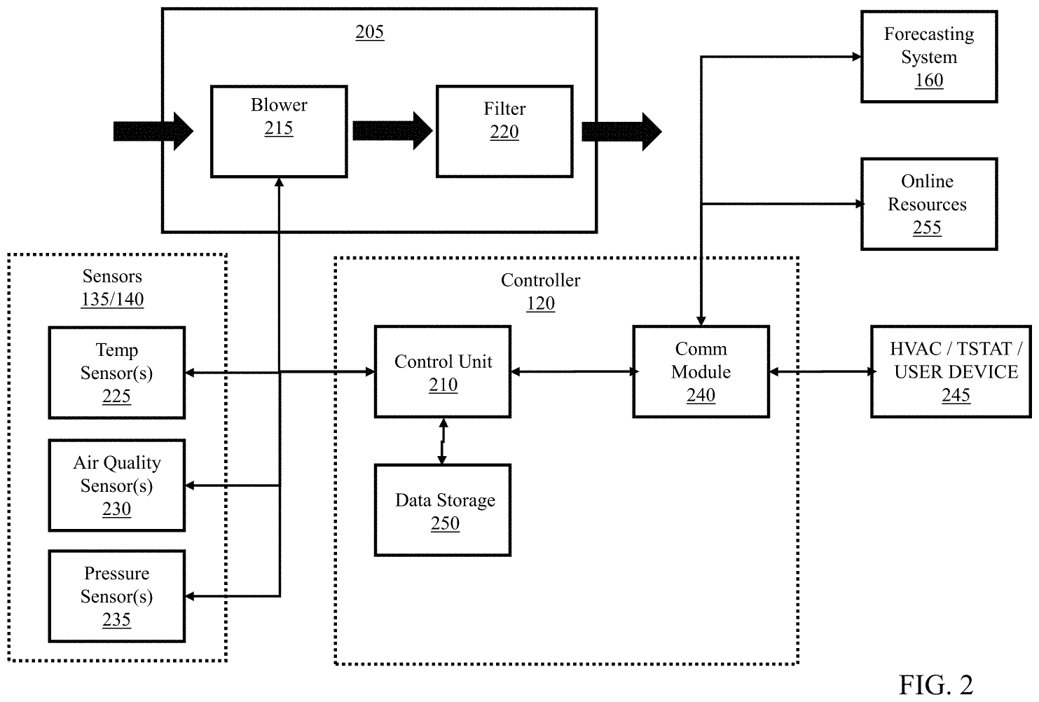

FIG. 2 is a block diagram depicting an exemplary AAES 200. In this example, the AAES 200 includes an air exchange unit 205 (of the ventilation system) controlled by the controller 120 that includes a control unit 210. For example, the air exchanger unit can be the makeup unit 125 and/or the exhaust unit 130. In some embodiments, the control unit 210 can be a stand-alone appliance. In some embodiments, the control unit 210 can be a software application installed in a computing device. In some embodiments, the control unit 210 can be an App installed in a mobile device. In this example, the air exchange unit 205 includes a blower 215 and a filter 220. For example, the control unit 210 can activate the blower 215 to pull outside air into the structure 100. In some implementations, the filter 220 filter particles and/or germs from outside air before the air enter the structure 100.

The control unit 210 is connected to the environmental sensors 135/140, for example, one or more temperature sensors 225, one or more air quality sensor 230, and one or more pressure sensors 235. In some embodiments, the control unit 210 can activate the air exchange unit 205 based on the data received from the sensors 225, 230, and 235. For example, the control unit 210 can activate the air exchange unit 205 to pull in fresh air when an indoor air quality is below an acceptable level. For example, the control unit 210 can activate the air exchange unit 205 to pull in fresh air when an indoor temperature is needed to be altered.

The control unit 210 includes a communication module 240 to communicate with other devices 245 such as the control thermostat, HVAC system, and user device. In some embodiments, the communication module 240 can utilize a wireless connection between one or more of the other devices 245. In some embodiments, the communication module 240 can utilize a wired connection between one or more of the other devices 245.

The AAES 200 can include a storage device 250. For example, the storage device 250 can include historical data of the air condition profiles. For example, the air condition profiles can include environmental statistics at different times of the day. In some implementation, the control unit 210 can use historical data to optimize the performance of the AAES 200 when making ventilation decisions. For example, the control unit 210 can apply a statistical model to predict a weather change to reduce power used by the central AC. As an illustrative example, the storage device 250 can include temperature data of the current location at 6 PM for the last 30 years. For example, the control unit 210 can use the data to predict a 90% chance that in one hour the temperature will decrease to lower than the user selected temperature. In some examples, based on the prediction, the control unit 210 can then deactivate the central HVAC 110 and activate the air exchange unit 205. In various implementations, the AAES 200 can advantageously use the historical data to predict weather changes to optimize power usage for indoor climate control. The control unit 210 is connected, via the communication module 240, to the forecasting system 160 and an online database 255. For example, the control unit 210 can use an application programming interface (API) to communicate with an online database for data useful for optimizing AAES performance. For example, the online database 255 can be connected to a weather station that provides local weather prediction data for next few hours. For example, the AAES 200 can use the weather prediction to optimize power usage for indoor climate control.

In embodiments, the AAES 200 can also selectively operate the air exchange unit 205 using artificial intelligence and machine learning algorithms that forecast the future environmental conditions for the structure 100 and provide adaptive ventilation decisions for the structure. The AAES can implement and train one or more environmental models for the structure that outputs ventilation decisions for the AAES 200. Likewise, the forecasting system 160 can operate a portion and/or all the one or more environmental models and communicate the ventilation decision to the control unit 210.

The data storage 250 and/or the forecasting system 160 can store a combination of factors used by the one or more environmental models such as user preferences, current interior and exterior environmental conditions, forecasted environmental conditions, historic environmental operations of the structures, historic environmental operations of the similar structures, e.g., similar in construction, HVAC system, geographic location, and climate zone, and the like. The environmental model can employ a combination of AI algorithms and methods to learn from the environmental parameters collected from indoor and outdoor sensors, weather data, and user preferences. The AAES 200 can utilize AI algorithms and methods to learn from the collected data and improve its forecasting and ventilation decision-making capabilities. The choice of algorithms and techniques depends on the specific requirements and constraints of the system, as well as the availability and quality of the data. The AAES 200 can utilize a combination of these methods would be employed to achieve the best results.

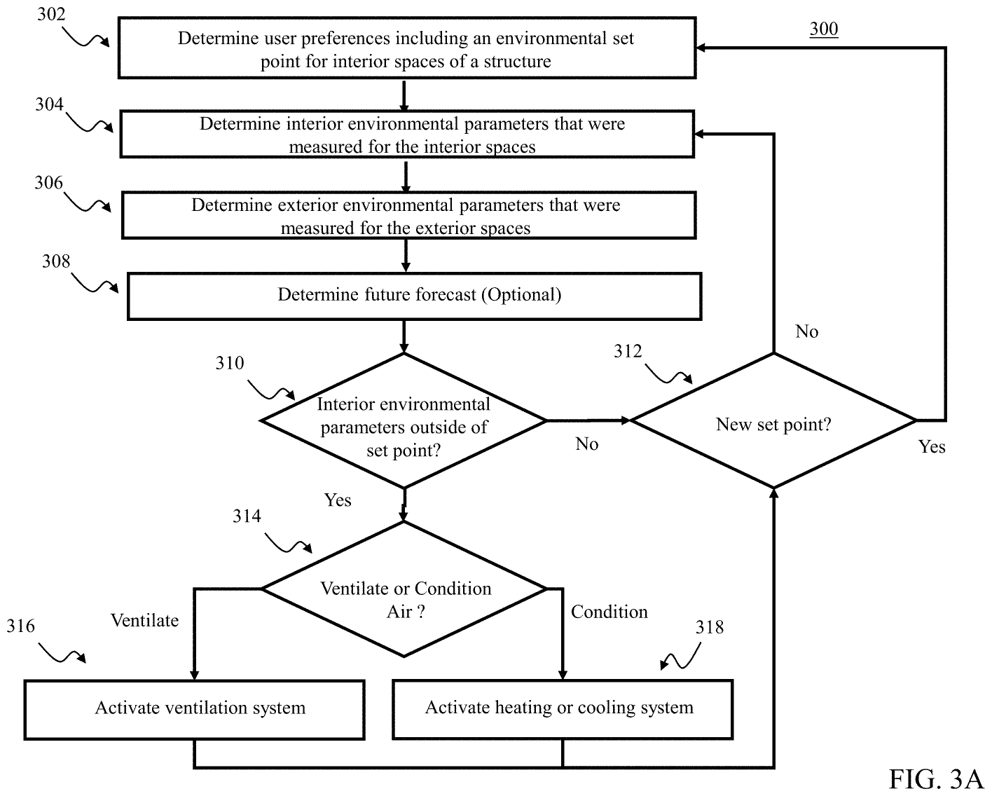

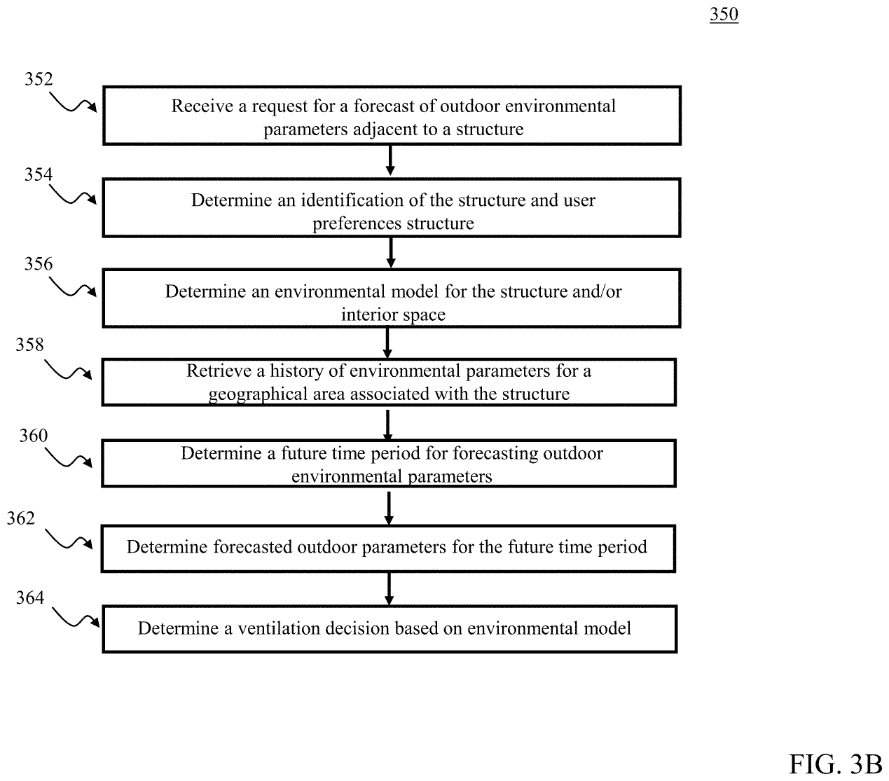

FIG. 3A is a flowchart illustrating an exemplary process 300 of selectively utilizing a ventilation system. The process 300 can be performed by any of the computerized systems of FIG. 1 and/or FIG. 2. For example, one or more of the steps of process 300 can be performed by the controller 120.

In step 302, user preferences including an environmental set point for interior spaces of a structure are determined. For example, a user can input the user preferences using the thermostat 115. Likewise, for example, a user can input the user preferences using a user device 150. The preferences can include environmental set points such as temperature, humidity, air quality. Likewise, the user preference can include a specific time duration for using the ventilation system and/or the HVAC unit.

In step 304, interior environmental parameters that were measured for the indoor spaces are determined. For example, the controller 120 can communicate with the interior environmental sensors 140 to determine the interior environmental parameters. For example, the interior environmental sensors 140 can measure environmental parameters such as temperature, air quality, humidity, aroma, air pressure, or a combination thereof. Air quality can include factors such as levels of carbon monoxide, lead, ground-level ozone, particulate matter, nitrogen dioxide, and sulfur dioxide.

In step 306, exterior environmental parameters that were measured for the exterior spaces are determined. For example, the controller 120 can communicate with the exterior environmental sensors 135 to determine the exterior environmental parameters. For example, the exterior environmental sensors 135 can measure environmental parameters such as temperature, air quality, humidity, aroma, air pressure, or a combination thereof. Air quality can include factors such as levels of carbon monoxide, lead, ground-level ozone, particulate matter, nitrogen dioxide, and sulfur dioxide.

In step 308, a future forecast can be determined (optional). For example, the controller 120 can communicate with the forecasting system 160 and/or other weather service. The controller 120 can determine the forecasted environmental conditions that are predicted to occur at or near the structure 100 during a future time period. For instance, the controller 120 can receive from the forecasting system 160 and/or other weather service a forecasted temperature, humidity, air quality, etc. for a 24 hour period. In embodiments, the controller 120 (and/or the forcasting system 160) can utilize historic data for the geographic area around the structure to determine the forecasted environmental conditions.

In step 310, it is determined if interior environmental parameters are outside of set point. If the interior environmental parameters are not outside of set point, in step 312, it is determined if a new set point has been received. If not, the process 300 returns to 304. If a new set point is received, the process 300 returns to step 302.

In step 314, a ventilation decision can be determined. For example, the controller 120 (and/or the forecasting system 160) can determine if activating the ventilation system or the HVAC 110 is the most efficient in meeting the user preferences for the environmental conditions of the structure.

In step 316, if the activation decision is positive, the ventilation system is activated. For example, the controller 120 can activate the ventilation system, e.g., the makeup unit 125 and the exhaust unit 130. In step 318, if the activation decision is negative, the heating and cooling system is activated. For example, the controller 120 can activate the HVAC 110.

For example, the user can select a temperature at the control thermostat 115 of 70° F. and a desired air quality level, e.g., for example, an Air Quality Index (AQI) of Good. The interior environmental sensors 140 can measure the AQI as Fair and the current room temperature is 70° F. In some implementations, the controller 120 can determine that the AQI has moved outside the user preference. The controller 120 can determine the exterior environmental parameters. If, for example, the outdoor temperature is within a range of the set point and the AQI is good, then the controller 120 can activate the makeup unit 125 to pull in air from outside. In some examples, to facilitate ventilation, the controller 120 can also activate the exhaust unit 130. Additionally, the controller 120 (and/or the forecasting system 160) can determine forecasted environmental parameters to determine if the ventilation should be used. For example, if the temperature is expected to increase significantly within the next few hours, the controller can determine a negative decision on the ventilation system due to increase in temperate differential between the interior and exterior, which would likely require use of the HVAC unit 110.

In some embodiments, the controller 120 can prevent the control thermostat 115 to activate the central HVAC 110. Accordingly, in various implementations, the AAES can advantageously save energy used for powering the central HVAC 110 and can advantageously improve indoor oxygen level and/or improve air quality by removing stale and/or pathogen-rich air from the structure 100. While the above example is described with reference to temperature and air quality, the process can operate for other environmental conditions or combinations of environmental conditions.

FIG. 3B is a flowchart illustrating an exemplary process 350 of determining a ventilation decision. The process 350 can be performed by any of the computerized systems of FIG. 1 and/or FIG. 2. For example, one or more of the steps of process 350 can be performed by the controller 120. Likewise, for example, one or more of the steps of the process 350 can be performed by the forecasting system 160.

In step 352, a request for a forecast of outdoor environmental parameters adjacent to a structure is received. For example, the controller can request an environmental forecast from the forecasting system 160 and a ventilation decision.

In step 354, an identification of the structure and user preferences structure is determined. For example, the request can include an identification of the structure 100, the user parameters from the structure 100, and any data that was collected. Likewise, the controller 120 may have previously sent the user parameters to the forecasting system 160.

In step 356, a forecasting model for the structure and/or interior space is determined. In step 358, a history of environmental parameters for a geographical area associated with the structure is determined. For example, the forecasting system 160 may have previously implemented and trained an environmental model for the structure 100, which can be retrieved based on the identification of the structure. Additionally, if the structure 100 is a newly requesting structure, the forecasting system 160 can train an environmental model for the structure 100.

The environmental model can be trained using data collected from the structure 100 by the controller 120. The data can include the environmental parameters measured over time. The one or more environmental models can also be trained using data collected from other structure that exhibit similar environmental properties to the structure 100. For example, data collected from structures that are geographically near the structure 100 can be used to train the one or more environmental models. Likewise, data collected from structures with similar constructions and dimensions can be used to train the one or more environmental models.

In step 360, a future time period for forecasting outdoor environmental parameters is determined. The forecasting system 160 can select a time period of a duration for which an accurate forecast can be made. For example, the forecasting system 160 can select a time period of 12 to 24 hours.

In step 362, forecasted outdoor parameters for the future time period are determined. In step 364, a ventilation decision based on the environmental model is determined. The ventilation represents a positive or negative decision to use the ventilation decision.

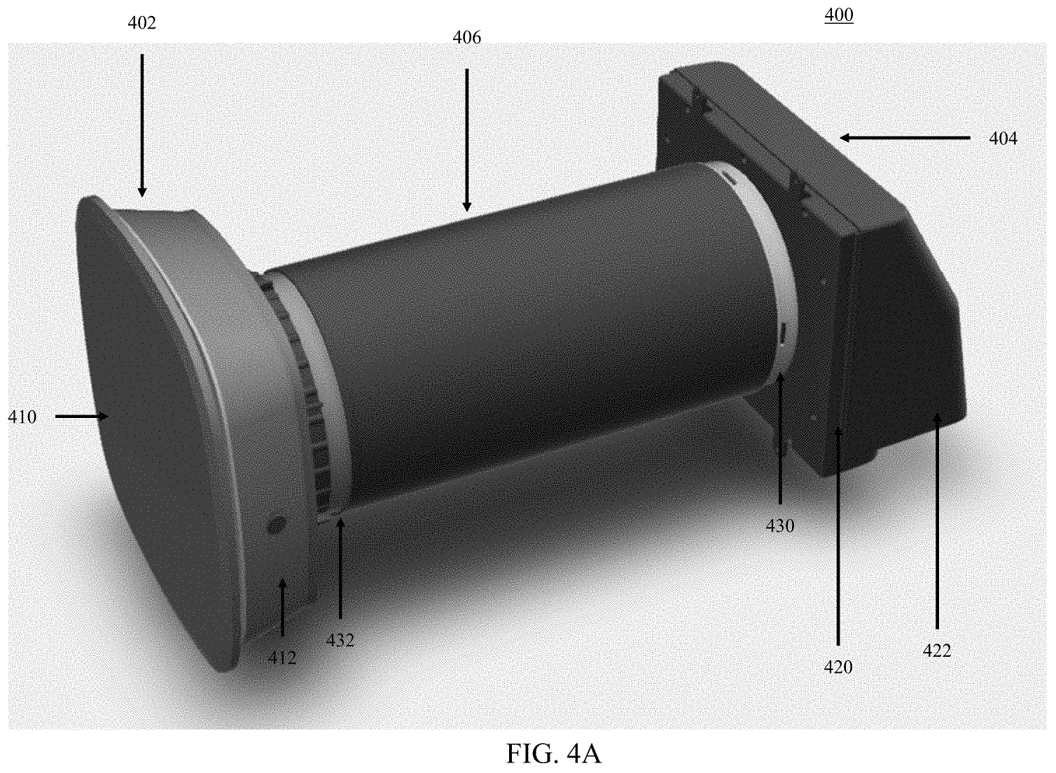

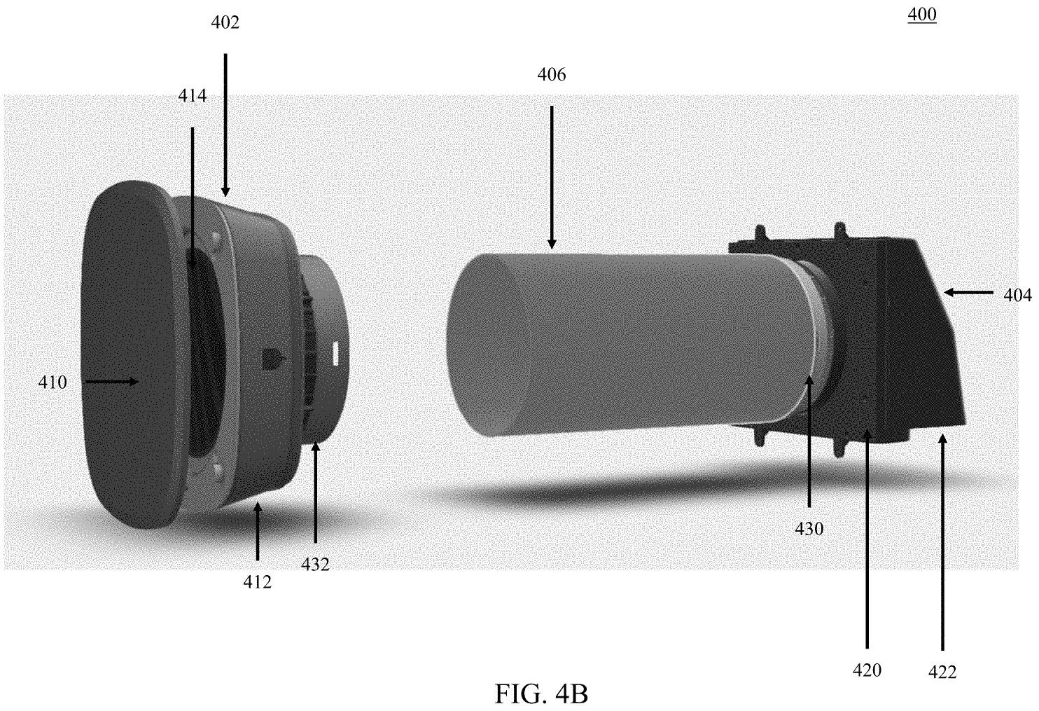

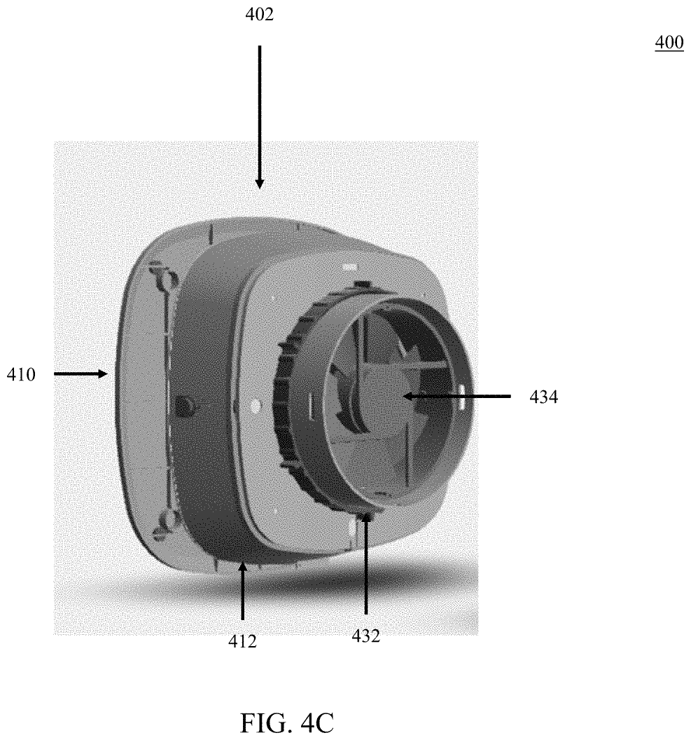

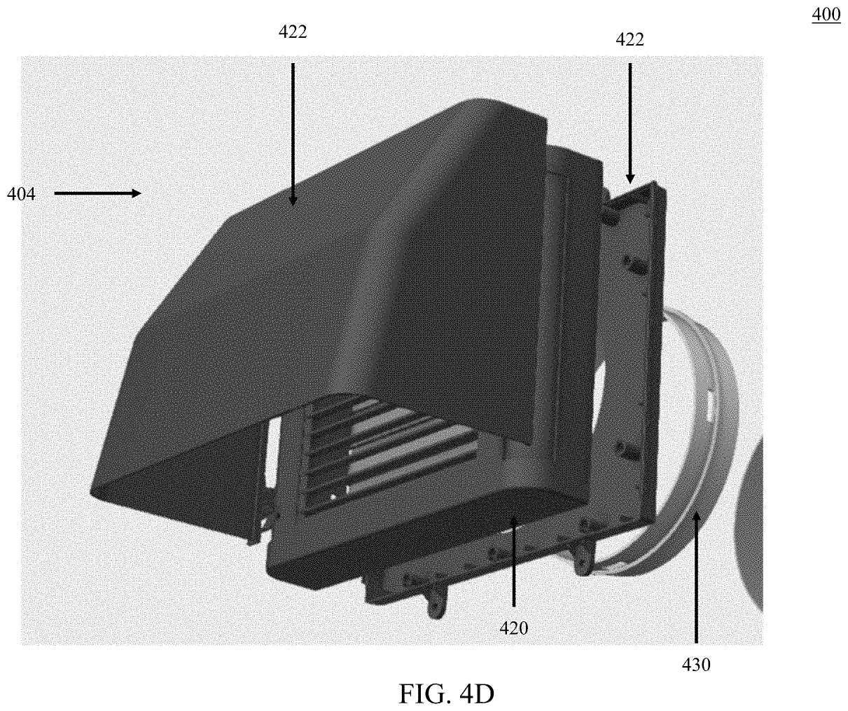

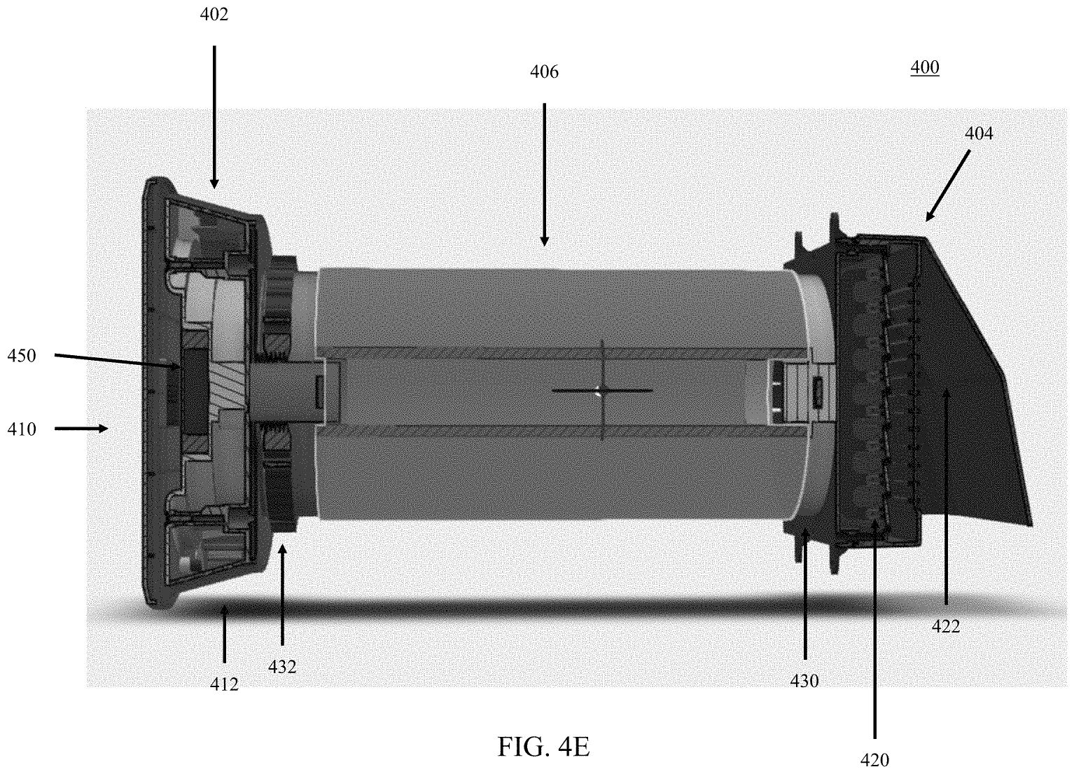

FIGS. 4A-4E depicts several views of an air exchange unit 400 that can be used in a ventilation system of a structure, for example, structure 100. FIG. 4A illustrates a perspective view of the air exchange unit 400. FIG. 4B illustrates a partially exploded view of the air exchange unit 400. As shown, the air exchange unit 400 includes an interior unit 402 and an exterior unit 404 connected by an air duct 406. The air exchange unit 400 can be connected to the outside of a house through a wall or other solid structure via an air duct 410.

The interior unit 402 includes a housing 412 with a cover 410. As illustrated in FIG. 4C, the interior unit 402 is coupled to air duct 406 by a blower 432. As illustrated in FIG. 4C, which is a partially exploded view of the blower 432, the blower 432 includes a fan 434. The exterior unit 404 includes a louvered body 420 with a backing 422 and a directional shield 422 that directs the airflow downward, as further illustrated in FIG. 4D, which in an exploded view. The exteriour unit 404 is coupled to the air duct 406 by a ring 430.

The air exchange unit 400 includes a filter 414 to clean incoming and/or outgoing air. As illustrated in FIG. 4E, which is a cross-sectional view, the filter 414 can also include a replacible aroma pad 450 to induce a user-selected aroma to the incoming air.

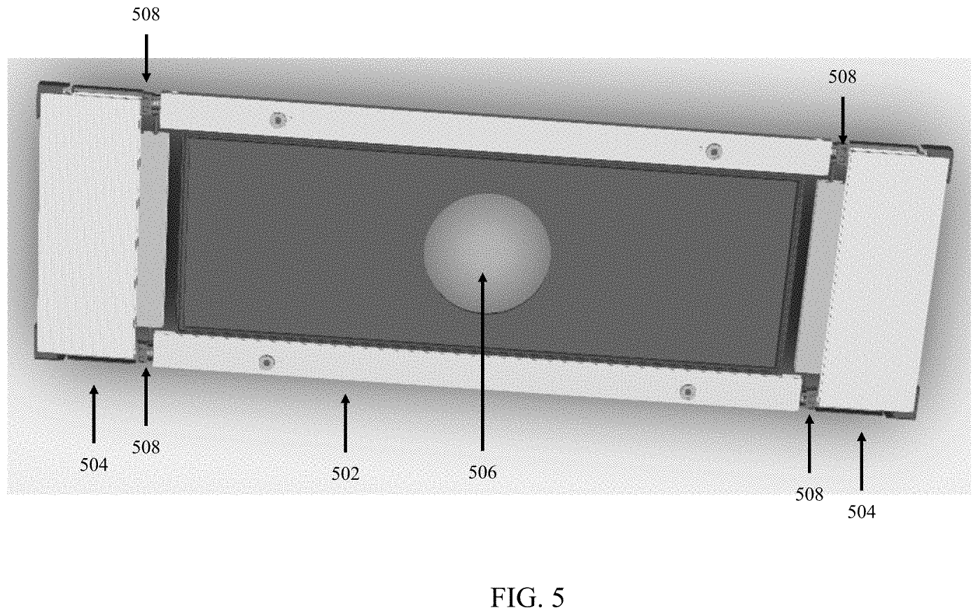

FIG. 5 depicts an exemplary window adapter 500 for installing an air exchange unit, e.g., air exchange unit 600, in a window or other opening. In this example, the window adapter includes a body 502 with expandable wings 504. The expandable wings 504 are coupled to the body by springs 508 that allow the wings to move relative to the body 502. The body includes an opening 506 that is configured to allow the air duct of the air exchange unit, e.g., air duct 406, to pass through and provide an air tight seal.

Although various embodiments have been described with reference to the figures, other embodiments are possible. In some embodiments, one or more components can be integrated. For example, the controller 120 can be physically embodied within the makeup unit 125 and/or exhaust unit 130. In some embodiments, by way of example and not limitation, the controller 120 can be a third-party control unit. A control and/or communication unit in the makeup unit 125 and/or exhaust unit 130 can be configured to communicate with and/or be controlled by the (third-party) controller 120. In some embodiments, for example, the controller 120 can include a home automation unit (e.g., central, distributed, remote, cloud). In some embodiments, for example, the controller 120 can include a personal computing device (e.g., computer, smartphone).

In some embodiments, a AAES can, for example, be built into a structure such as, for example, a multi-purpose ventilation system. For example, a AAES can be configured as an exhaust system for a building space (e.g., a bathroom). For example, a makeup unit 125 and/or exhaust unit 130 can be implemented as one or more exhaust systems (e.g., bathroom exhaust, kitchen exhaust). In some embodiments, for example, the units can be in a same room. In some embodiments, for example, the units can be in separate rooms. A controller 120 can, for example, advantageously control one or more units of one or more AAES (e.g., in the same room, in different rooms). For example, the controller 120 can operate the units individually and/or simultaneously based on air quality parameters. For example, in response to an odor sensor (e.g., particulate sensor, VOC sensor), the controller 120 can operate the AAES to reduce odor below a (predetermined) threshold, such as in a bathroom. In some embodiments, for example, the controller 120 can operate the AAES 100 in response to a temperature sensor and/or a smoke sensor in order to restore a desired (e.g., predetermined) air quality in a kitchen. In some embodiments, the controller 120 can selectively operate various units of the AAES 100 based off of multi-factor parameters (e.g., indoor temperature, outdoor temperature, indoor air quality, outdoor air quality, user commands) in order to balance various parameters (e.g., reduce temperature swings while maintaining air purity).

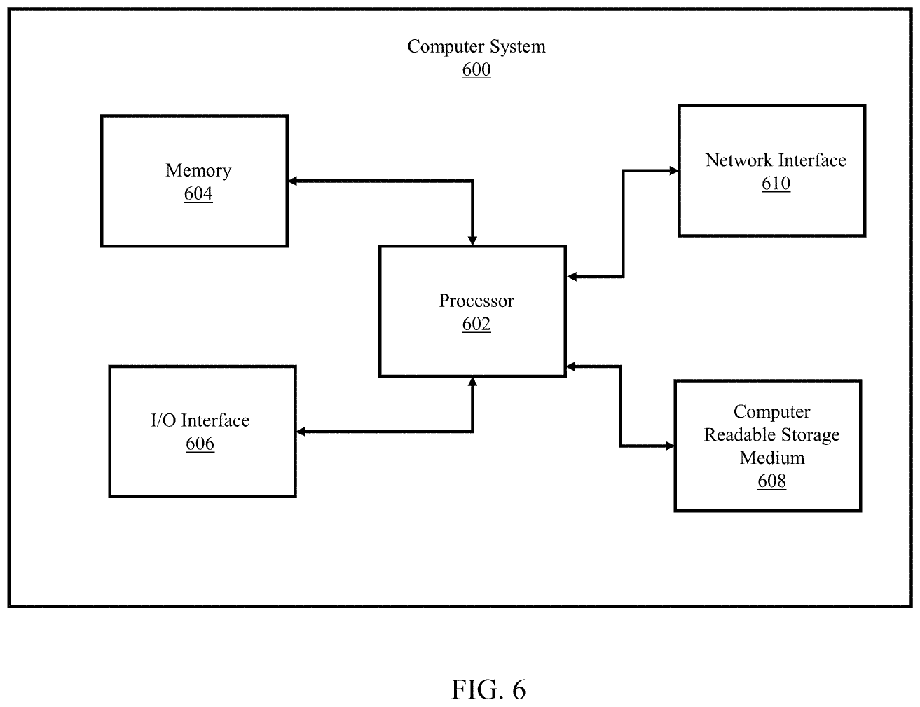

FIG. 6 is a block diagram of an example computer system 600 according to an example of the present disclosure. For example, the computer system 600 can be used to implement the controller 120 of FIGS. 1 and 2 and/or the network resources, as well as to provide computing resources as described herein. In some implementations, the computer system 600 can include one or more processors 602, one or more memories 604, one or more input/output (I/O) interfaces 606, computer-readable storage media 608, and one or more network interfaces 710. In various implementations, the processor 602 can be used to implement various functions and features described herein, as well as to perform the method implementations described herein. The processor 602 can be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” can be used generically to refer to any or all of the aforementioned specific devices, elements, and/or features of the processing device. While the processor 602 is described as performing implementations described herein, any suitable component or combination of components of the computer system 600 or any suitable processor or processors associated with the computer system 600 or any suitable system can perform the steps.

The non-transitory computer-readable storage medium 608 can be any electronic, magnetic, optical, or other physical storage device that stores executable instructions. For example, the non-transitory computer-readable storage medium 608 can be random access memory (RAM), an electrically-erasable programmable read-only memory (EEPROM), a storage drive, an optical disc, or the like. The non-transitory computer-readable storage medium 708 can be encoded to store executable instructions that cause a processor to perform operations according to examples of the disclosure.

The network interface 610 can be configured to communicate with one or more network via one or more communication links. Communication links can be direct or indirect. A direct link can include a link between two devices where information is communicated from one device to the other without passing through an intermediary. For example, the direct link can include a Bluetooth™ connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link can include a cable on a bus network. “Direct,” when used regarding the communication links, can refer to any of the aforementioned direct communication links.

An indirect link can include a link between two or more devices where data can pass through an intermediary, such as a router, before being received by an intended recipient of the data. For example, the indirect link can include a wireless fidelity (WiFi) connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links can refer to any of the aforementioned indirect communication links.

The various computing devices described herein are exemplary and for illustration purposes only. The system can be reorganized or consolidated, as understood by a person of ordinary skill in the art, to include more or fewer components and/or to perform the same tasks on one or more other servers or computing devices without departing from the scope of the invention. Generally, the techniques disclosed herein can be implemented on hardware or a combination of software and hardware. For example, they can be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein can be implemented on a programmable network-resident machine (which should be understood to include intermittently connected network-aware machines) selectively activated or reconfigured by a computer program stored in memory. Such network devices can have multiple network interfaces that can be configured or designed to utilize different types of network communication protocols. A general architecture for some of these machines can be described herein in order to illustrate one or more exemplary means by which a given unit of functionality can be implemented. According to specific embodiments, at least some of the features or functionalities of the various embodiments disclosed herein can be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein can be implemented in one or more virtualized computing environments (e.g., network computing clouds, virtual machines hosted on one or more physical computing machines, or other appropriate virtual environments). Any of the above mentioned systems, units, modules, engines, components or the like can be and/or comprise hardware and/or software as described herein.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various embodiments are directed to systems and method for selectively controlling and HVAC and ventilation system. Any of the below embodiments can be performed using the systems described in FIGS. 1 and 2. Likewise, any of the below embodiments can be incorporated the processes described in FIGS. 3A and 3B.

Embodiment 1 concerns a method of operating a heating, air conditioning, and ventilation (HVAC) system. The method includes determining one or more user preferences for environmental conditions in a structure. The one or more user preferences include one or more environmental set points for an interior space of the structure. The environmental conditions include one or more factors including temperature, humidity, and air quality. The method also includes determining one or more interior environmental parameters measured for the interior space, the one or more environmental parameters including at least one of interior temperature, interior humidity, or interior air quality. The method also includes determining one or more exterior environmental parameters measured for an exterior space outside the structure, the one or more exterior environmental parameters including at least one of exterior temperature, exterior humidity, and exterior air quality. Further, the method includes determining a ventilation decision based one or more of the one or more user preferences, the one or more interior environmental parameters, the one or more exterior environmental parameters, and one or more forecasted exterior environmental parameters. The method includes, if the ventilation decision is positive, activating an air circulation system that causes an airflow between the exterior space and the interior space, wherein the air circulation system includes one or more pathways between the interior space and the exterior space and one or more blowers to move air through the one or more pathways. The method also includes, if the ventilation decision is negative, activating an air conditioning system or a heating system.

Embodiment 2 concerns the method of embodiment 1, where the method further includes determining that one or more interior environmental parameters trigger a determination of the ventilation decision based on a comparison with of the one or more interior environmental parameters with the one or more environmental set points.

Embodiment 3 concerns the method of embodiment 1, where the method further includes activating the air circulation system when one or more forecasted exterior environmental parameters are within the predetermined range of the one or more interior environmental parameters during a future time period.

Embodiment 4 concerns the method of embodiment 3, where the method further includes determining, during the future time period, that one or more new exterior environmental parameters for the exterior space; and if the one or more new exterior environmental parameters are not within the predetermined range of the one or more interior environmental parameters, activating the air conditioning system or the heating system.

Embodiment 5 concerns the method of embodiment 1, where the ventilation decision is determined based on an application of one or more of the one or more user preferences, the one or more interior environmental parameters, the one or more exterior environmental parameters, and one or more forecasted exterior environmental parameters to a machine learning model for predicting potential environmental conditions associated with the structure.

Embodiment 6 concerns the method of embodiment 5, where the machine learning model utilizes one or more of supervised learning algorithms, time series forecasting algorithms, clustering algorithms, nearest neighbor search algorithms, collaborative filtering techniques, reinforcement learning algorithms, or advanced learning algorithms.

Embodiment 7 concerns the method of embodiment 4, wherein the method further includes transmitting, to a remote location, one or more measured exterior environmental parameters for the exterior space during the future time period, wherein the one or more measured exterior environmental parameters are stored in the history of environmental parameters.

Embodiment 8 concerns the method of embodiment 1, where the air quality comprises values for carbon monoxide, lead, ground-level ozone, particulate matter, nitrogen dioxide, and sulfur dioxide.

Embodiment 9 concerns a method of optimizing environmental systems. The method includes receiving a request for a ventilation decision for a structure. The request includes one or more user preferences including environmental set points for environmental conditions in an interior space of the structure, one or more interior environmental parameters measured within the interior space, and one or more exterior environmental parameters measured within an exterior space outside the interior space. The environmental conditions include one or more factors including temperature, humidity, and air quality. The method includes retrieving a history of environmental parameters for a geographical area associated with the structure. The method also includes determining one or more forecasted exterior parameters adjacent to the structure. The one or more forecasted exterior parameters includes at least one of forecasted exterior temperature, forecasted exterior humidity, or forecasted exterior air quality. The method also includes applying, to a machine learning model of the structure, the one or more forecasted exterior parameters and the one or more user preferences including environmental set points for environmental conditions in an interior space of the structure, one or more interior environmental parameters measured within the interior space, and one or more exterior environmental parameters measured within an exterior space outside the interior space. Further, the method includes determining a ventilation decision from an output of the machine learning model of the structure. The ventilation decision controls the activation of one or more of an air circulation system, an air conditioning system, or a heating system of the structure. The air circulation includes one or more pathways between the interior space and the exterior space and one or more blowers to move air through the one or more pathways. The method includes transmitting the ventilation decision to one or more of the air circulation system, the air conditioning system, or the heating system of the structure.

Embodiment 10 concerns the method of embodiment 9, where the air quality comprises values for carbon monoxide, lead, ground-level ozone, particulate matter, nitrogen dioxide, and sulfur dioxide.

Embodiment 11 concerns the method of embodiment 9, where the method further includes training the machine learning model of the structure with a history of measured environmental parameters for the structure.

Embodiment 12 concerns the method of embodiment 11, where the method further includes determining the geographical area associated with the structure based on the climate zone for the structure; collecting additional measured environmental parameters from additional HVAC systems within the geographical area; and training the machine learning model of the structure with additional measured environmental parameters.

Embodiment 13 concerns the method of embodiment 9, wherein the method further includes determining a future time period for an application of the ventilation decision.

Embodiment 11 concerns a system from controlling the environment of a structure. The system includes a heating and cooling system and a ventilation system configured to circulate air between an interior space and an exterior space of the structure. The ventilation system includes one or more blowers and one or more pathways between the interior space and the exterior space. The system includes one or more interior environmental sensors configured to measure one or more interior environmental parameters; one or more exterior environmental sensors configured to measure one or more exterior environmental parameters; and a control system coupled to the heating and cooling system, the ventilation system, the one or more interior environmental sensors, and the one or more exterior environmental sensors. The control system is configured to: receive an environmental set point for the interior space, and selectively activate the heating and cooling system or the ventilation system based on analysis of the one or more interior environmental parameters and the one or more exterior environmental parameters.

Embodiment 15 concerns the system of embodiment 14, where the control system further comprises one or more communication interfaces. The control system utilizes the one or more communication interfaces to communicate with a forecasting system to request an environmental score based on the one or more forecasted exterior parameters. The environmental score represents a likelihood activating heating and cooling system will be required to maintain the environmental set point during a future time period.

Embodiment 16 concerns the system of embodiment 15, where the one or more forecasted exterior environmental parameters are predicted based on a history of environmental parameters for a geographical area associated with the structure.

Embodiment 17 concerns the system of embodiment 16, wherein the control system is configured to transmit, via the one or more communication interfaces, one or more measured exterior environmental parameters for the exterior space during the future time period. The one or more measured exterior environmental parameters are stored in the history of environmental parameters.

Embodiment 18 concerns the system of embodiment 14, where the environmental set point comprises one or more factors including temperature, humidity, and air quality.

Embodiment 19 concerns the system of embodiment 18, where the air quality comprises values for carbon monoxide, lead, ground-level ozone, particulate matter, nitrogen dioxide, and sulfur dioxide.

Embodiment 20 concerns the system of embodiment 14, where the control system is further configured to: determine that one or more interior environmental parameters trigger a conditional of the interior space based on a comparison with the environmental set point; if the one or more exterior environmental parameters are within a predetermined range of the one or more interior environmental parameters, activate the ventilation system that causes an airflow between the exterior space and the interior space; and if the one or more exterior environmental parameters are not within the predetermined range of the one or more interior environmental parameters, activate the heating and cooling system.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments can be described using the expression “coupled” and “connected” along with their derivatives. For example, some embodiments can be described using the term “coupled” to indicate that two or more elements are in direct physical or electrical contact. The term “coupled,” however, can also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or

B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations can be made in the arrangement, operation and details of the method and apparatus disclosed herein without departing from the spirit and scope defined in the appended claims.

What is claimed is:

1. A method of operating a heating, air conditioning, and ventilation (HVAC) system, the method comprising:
determining one or more user preferences for environmental conditions in a structure, wherein:
the one or more user preferences comprise one or more environmental set points for an interior space of the structure, and
the environmental conditions comprise one or more factors including temperature, humidity, and air quality;
determining one or more interior environmental parameters measured for the interior space, the one or more environmental parameters comprising at least one of interior temperature, interior humidity, or interior air quality;
determining one or more exterior environmental parameters measured for an exterior space outside the structure, the one or more exterior environmental parameters comprising at least one of exterior temperature, exterior humidity, and exterior air quality;
determining a ventilation decision based one or more of the one or more user preferences, the one or more interior environmental parameters, the one or more exterior environmental parameters, and one or more forecasted exterior environmental parameters;
if the ventilation decision is positive, activating an air circulation system that causes an airflow between the exterior space and the interior space, wherein the air circulation system comprises one or more pathways between the interior space and the exterior space and one or more blowers to move air through the one or more pathways; and
if the ventilation decision is negative, activating an air conditioning system or a heating system.

2. The method of claim 1, the method further comprising:
determining that one or more interior environmental parameters trigger a determination of the ventilation decision based on a comparison with of the one or more interior environmental parameters with the one or more environmental set points.

3. The method of claim 1, the method further comprising:
activating the air circulation system when one or more forecasted exterior environmental parameters are within the predetermined range of the one or more interior environmental parameters during a future time period.

4. The method of claim 3, the method further comprising:
determining, during the future time period, that one or more new exterior environmental parameters for the exterior space; and
if the one or more new exterior environmental parameters are not within the predetermined range of the one or more interior environmental parameters, activating the air conditioning system or the heating system.

5. The method of claim 1, wherein the ventilation decision is determined based on an application of one or more of the one or more user preferences, the one or more interior environmental parameters, the one or more exterior environmental parameters, and one or more forecasted exterior environmental parameters to a machine learning model for predicting potential environmental conditions associated with the structure.

6. The method of claim 5, wherein the machine learning model utilizes one or more of supervised learning algorithms, time series forecasting algorithms, clustering algorithms, nearest neighbor search algorithms, collaborative filtering techniques, reinforcement learning algorithms, or advanced learning algorithms.

7. The method of claim 4, the method further comprising:
transmitting, to a remote location, one or more measured exterior environmental parameters for the exterior space during the future time period, wherein the one or more measured exterior environmental parameters are stored in the history of environmental parameters.

8. The method of claim 1, wherein the air quality comprises values for carbon monoxide, lead, ground-level ozone, particulate matter, nitrogen dioxide, and sulfur dioxide.

9. A method of optimizing environmental systems, the method comprising:
receiving a request for a ventilation decision for a structure, wherein:
the request comprises one or more user preferences including environmental set points for environmental conditions in an interior space of the structure, one or more interior environmental parameters measured within the interior space, and one or more exterior environmental parameters measured within an exterior space outside the interior space, and
the environmental conditions comprise one or more factors including temperature, humidity, and air quality;
retrieving a history of environmental parameters for a geographical area associated with the structure;
determining one or more forecasted exterior parameters adjacent to the structure, wherein the one or more forecasted exterior parameters comprises at least one of forecasted exterior temperature, forecasted exterior humidity, or forecasted exterior air quality;
applying, to a machine learning model of the structure, the one or more forecasted exterior parameters and the one or more user preferences including environmental set points for environmental conditions in an interior space of the structure, one or more interior environmental parameters measured within the interior space, and one or more exterior environmental parameters measured within an exterior space outside the interior space
determining a ventilation decision from an output of the machine learning model of the structure, wherein the ventilation decision controls the activation of one or more of an air circulation system, an air conditioning system, or a heating system of the structure, wherein the air circulation system comprises one or more pathways between the interior space and the exterior space and one or more blowers to move air through the one or more pathways; and
if the ventilation decision is negative, activating an air conditioning system or a heating system; and
transmitting the ventilation decision to one or more of the air circulation system, the air conditioning system, or the heating system of the structure.

10. The method of claim 9, wherein the air quality comprises values for carbon monoxide, lead, ground-level ozone, particulate matter, nitrogen dioxide, and sulfur dioxide.

11. The method of claim 9, the method further comprising:
training the machine learning model of the structure with a history of measured environmental parameters for the structure.

12. The method of claim 11, the method further comprising:
determining the geographical area associated with the structure based on the climate zone for the structure;
collecting additional measured environmental parameters from additional HVAC systems within the geographical area; and
training the machine learning model of the structure with additional measured environmental parameters.

13. The method of claim 9, the method further comprising:
determining a future time period for an application of the ventilation decision.

14. A system from controlling the environment of a structure, the system comprising:
a heating and cooling system;
a ventilation system configured to circulate air between an interior space and an exterior space of the structure, the ventilation system comprising one or more blowers and one or more pathways between the interior space and the exterior space;
one or more interior environmental sensors configured to measure one or more interior environmental parameters;
one or more exterior environmental sensors configured to measure one or more exterior environmental parameters; and
a control system coupled to the heating and cooling system, the ventilation system, the one or more interior environmental sensors, and the one or more exterior environmental sensors, wherein the control system is configured to:
receive an environmental set point for the interior space, and
selectively activate the heating and cooling system or the ventilation system based on analysis of the one or more interior environmental parameters and the one or more exterior environmental parameters.

15. The system of claim 14, wherein:
the control system further comprises one or more communication interfaces,
the control system utilizes the one or more communication interfaces to communicate with a forecasting system to request an environmental score based on the one or more forecasted exterior parameters, and
the environmental score represents a likelihood activating heating and cooling system will be required to maintain the environmental set point during a future time period.

16. The system of claim 15, wherein the one or more forecasted exterior environmental parameters are predicted based on a history of environmental parameters for a geographical area associated with the structure.

17. The system of claim 16, wherein the control system is further configured to:
transmit, via the one or more communication interfaces, one or more measured exterior environmental parameters for the exterior space during the future time period, wherein the one or more measured exterior environmental parameters are stored in the history of environmental parameters.

18. The system of claim 14, wherein the environmental set point comprises one or more factors including temperature, humidity, and air quality.

19. The system of claim 18, wherein the air quality comprises values for carbon monoxide, lead, ground-level ozone, particulate matter, nitrogen dioxide, and sulfur dioxide.

20. The system of claim 14, wherein the control system is further configured to:
determine that one or more interior environmental parameters trigger a conditional of the interior space based on a comparison with the environmental set point;
if the one or more exterior environmental parameters are within a predetermined range of the one or more interior environmental parameters, activate the ventilation system that causes an airflow between the exterior space and the interior space; and
if the one or more exterior environmental parameters are not within the predetermined range of the one or more interior environmental parameters, activate the heating and cooling system.
